(19) United States
(12) Patent Application Publication
(10) Pub. No.: US 2015/0379902 A1
(43) Pub. Date: Dec. 31, 2015

(54) 3-DIMENSIONAL COACHING BOARD

(71) Applicant: Fox 40 International Inc., Hamilton (CA)

(72) Inventors: David Ronald Foxcroft, Hamilton, CA (US); Gareth Edwards, Toronto, CA (US)

(73) Assignee: Fox 40 International Inc., Hamilton (CA)

(21) Appl. No.: 14/715,712

(22) Filed: May 19, 2015

Related U.S. Application Data
(60) Provisional application No. 62/016,936, filed on Jun. 25, 2014.

(51) Int. Cl. G09B 29/00

(52) U.S. Cl. CPC G09B 29/001

(57) ABSTRACT

The present concept is a coaching board in combination with an image displayed thereon. The combination includes a planar coaching board with at least one erasable writing surface and a 3-D image displayed on the erasable writing surface. The 3-D image is a graphic depiction of a sports playing area and includes horizontal and vertical features. The image is a perspective view of at least a portion of the playing area shown at an angle of approximately 15° to 85° relative to the horizontal. The sports playing area is chosen from among ice hockey rink, baseball diamond, volleyball court, American football field, soccer pitch, and basketball court.

The present invention claims priority to U.S. provisional patent application No. 62/016,936 filed on Jun. 25, 2014, having inventors David Ronald Foxcroft and Gareth Edwards.

### FIELD OF THE INVENTION

The present concept relates to coaching boards and more particularly relates to coaching boards which include a 3-dimensional perspective view of the playing surface.

### BACKGROUND OF THE INVENTION

Within sporting situations Athletic Instructors and Coaches are called upon to deliver clear directives to their participants. These directives often include positioning, coordinating and moving multiple participants relative to one another on the playing surface. These directives may further include coordination of a ball, puck or other sporting equipment to implement a strategy.

Presently, this coordination is either delivered through oral instruction, manually positioning players on the surface of play, or through a scaled coaching aid such as a miniature model or coaching board.

These coaching boards minimize the number of independent parts and are often favored by coaches over miniature models for that reason. The boards further appear in various sizing from standard letter paper (8.5 by 11 inches) clip boards, slightly larger carry boards to large wall mounted surfaces. Additionally, these boards typically allow for erasable content on a blank surface or a surface with a two dimensional aerial view of a playing surface showing major markings scaled down appropriately.

The benefit of a pre-printed two dimensional aerial image of a playing surface is that the instructor is not required to recreate the playing surface every time a new scheme is to be drawn as the playing surface is not erased along with the previous erasable content.

The limitation of a two dimensional image of a playing surface on coaching aids is that it does not accurately represent the perspective participants have when they are physically on the playing surface. Specifically the depth of play.

Additionally, the lack of a third dimension prevents instructors from visually delivering directives in the third dimension of play present in many athletic events. For example: a two dimensional board is incompatible with visual directives to play a volleyball to a certain height over the net during a volleyball match.

Therefore there is a need for a coaching aid that better represents the depth of play a participant would encounter and also a need to facilitate instruction in the third dimension of play.

### SUMMARY OF THE INVENTION

The present concept of a 3-Dimensional Coaching Board having a realistic color, texture and layout designed to display a playing surface that is better representative of a participant's real-world experience, and unexpectedly allows one to develop a strategy and give meaningful directives in the vertical direction of the playing surface.

The present concept of 3-dimensional coaching boards have a life-like playing surfaces. For example: the playing surface of the sport of hockey, a hockey rink, appears as a blue color with major marking lines to show skate marks on the ice; or the playing surface for the sport of soccer, a soccer field, shows a true to life grass texture.

The 3-Dimensional Coaching Board Concept shows a 3 dimensional image allowing for instruction in three dimensions and provides participants with a consistent experience in both teaching and practice.

The 3-dimensional image is especially important for teaching as it allows instructors to provide a more relevant and genuine demonstration compared to two dimensional images which force participants to rely on their own perception of depth once on the surface of play.

The present concept a coaching board in combination with an image displayed thereon, the combination comprising:
a) a planar coaching board with at least one erasable writing surface;
b) a 3-D image displayed on the erasable writing surface, the 3-D image is a graphic depiction of a sports playing area and includes both horizontal features and vertical features in a perspective view;
c) wherein the 3-D image is a perspective view of at least a portion of the playing area shown at a viewing angle of approximately 15° to 85° relative the horizontal.

Preferably wherein the sports playing area is chosen from among ice hockey rink, baseball diamond, volleyball court, American football field, soccer pitch, and basketball court.

Preferably wherein the horizontal feature includes a playing surface.

Preferably wherein the playing surface is chosen from among, ice surface, basketball court, volleyball court, baseball diamond, soccer pitch, football field, and basketball court.

Preferably wherein the vertical features is chosen from among, hockey boards, hockey safety glass, hockey net, soccer net, basketball net, football uprights, volleyball net, and baseball back walls.

Preferably wherein the 3-D image is a perspective view of at least a portion of the play surface shown at an angle of approximately 35° to 55° relative the horizontal.

Preferably wherein the playing surface including horizontal features selected from among boundary lines, face off circles, designated areas, and bases.

Preferably wherein the planar coaching board including a clip board.

Preferably wherein the planar coaching board includes a carry board.

Preferably wherein the planar coaching board includes a wallboard.

Preferably wherein at least one half of playing area is depicted on the planar coaching board.

### BRIEF DESCRIPTION OF THE DRAWINGS

The present concept will now be described by way of example only with reference to the following drawings in which:

FIG. 1 is a schematic plan view of a back face of a clipboard displaying a partial 3-Dimensional image of a hockey rink.

FIG. 2 is a schematic plan view of a front face of a clip board displaying a 2-dimensional image of a hockey playing surface.

FIG. 3 is a schematic plan view of a back face of a clipboard displaying a partial 3-D image of a hockey rink at a 20 degree angle relative to the horizontal.

FIG. 4 is a schematic plan view of a back face of a clipboard displaying a partial 3-D image of a hockey rink at a 45 degree angle relative to the horizontal.

FIG. 5 is a schematic plan view of a back face of a clipboard displaying a partial 3-D image of a hockey rink at a 85 degree angle relative to the horizontal.

FIG. 6 is a schematic plan view of a back face of a carry board displaying a partial 3-D image of a football field at a 45 degree angle relative to the horizontal.

FIG. 7 is a schematic plan view of a back face of a carry board displaying a partial 3-D image of a volleyball court at a 45 degree angle relative to the horizontal.

FIG. 8 is a schematic plan view of a back face of a carry board displaying a partial 3-D image of a basketball court at a 45 degree angle relative to the horizontal.

### DETAILED DESCRIPTION OF THE PREFERRED EMBODIMENTS

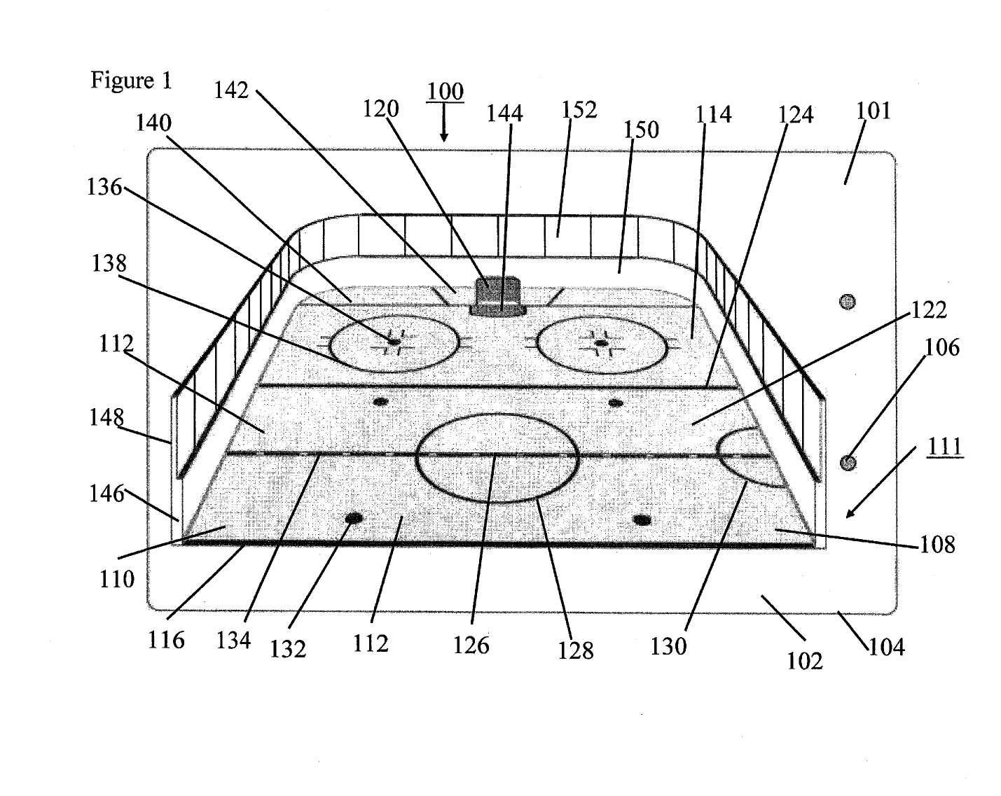

The present concept a 3-dimensional coaching board is shown generally as 100 in FIG. 1. Coaching board 100 may be a clip board, a larger carry board or a very large wall board. In each case the coaching board 100 includes at least one surface which is an erasable writing surface such as a dry erase white board.

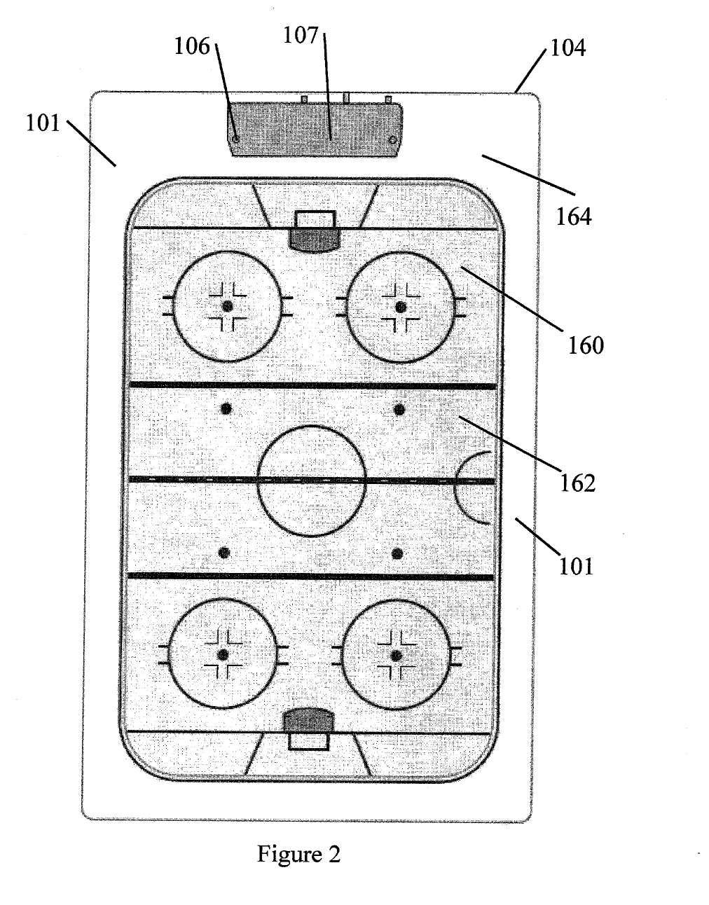

FIG. 1 shows a planar coaching board which in this example is clipboard back face 102 which is an erasable writing surface of a clipboard 101 which has a clipboard periphery 104 and as well shows clipboard fasteners 106. Clipboard fasteners 106 are normally rivets however they may be any fastening means that are used in the art for fastening the clip mechanism 107 shown in FIG. 2 to the clipboard 101.

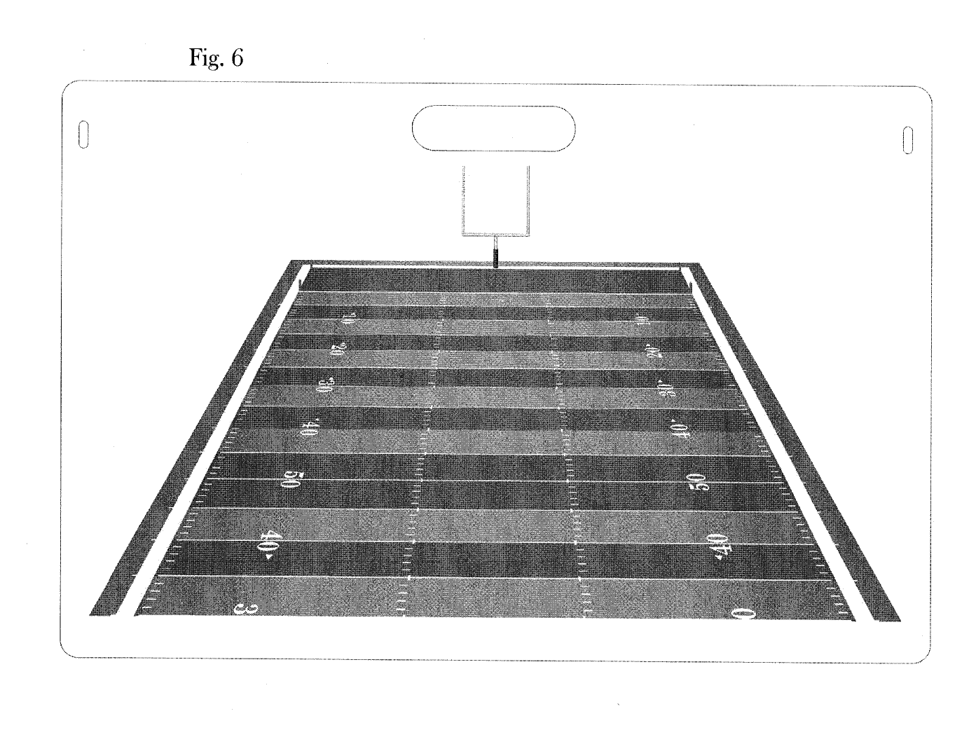

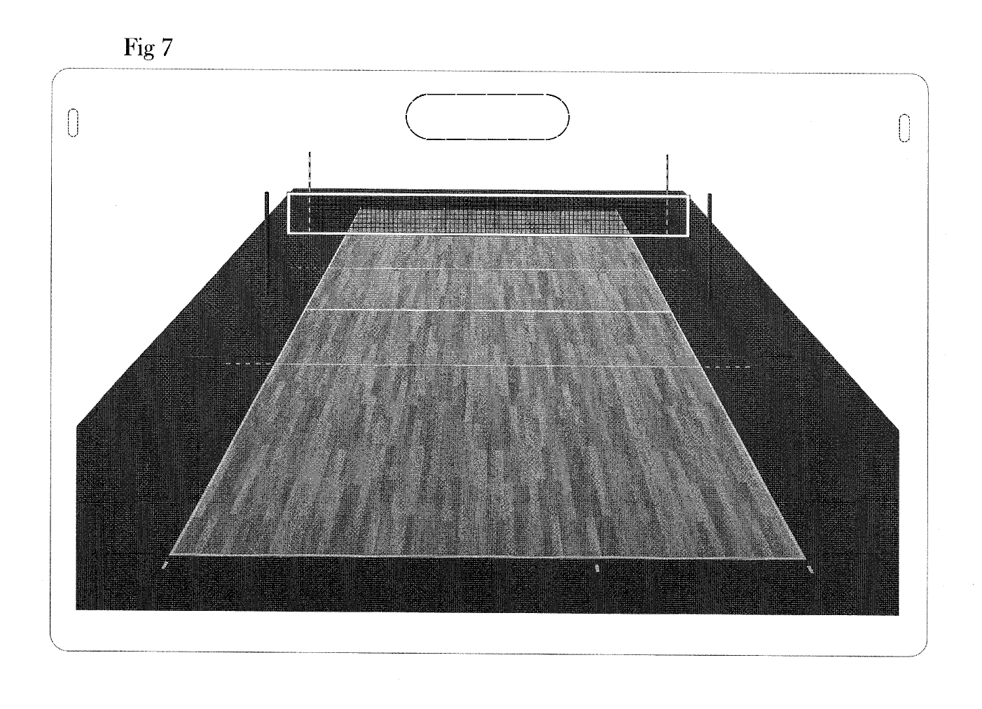

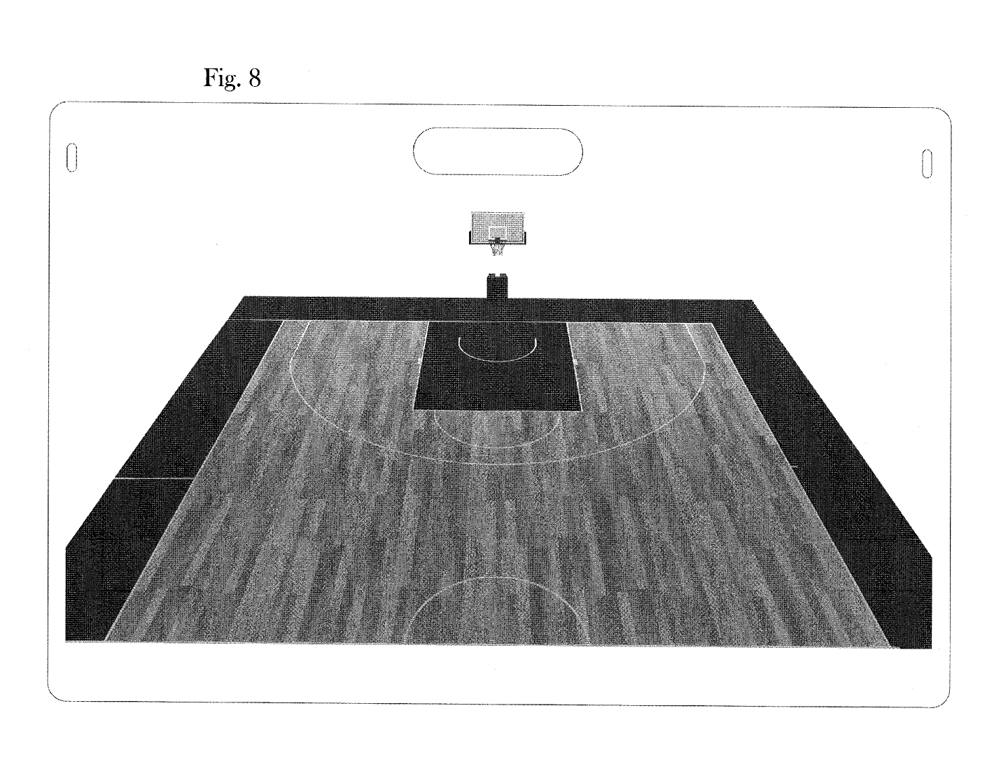

The planar coaching board may be a clip board, a carry board as depicted in FIGS. 6, 7 and 8 or a wallboard which generally is a planar surface mounted onto a wall. These boards would have at least one dry erasable surface upon which the 3-D image is depicted.

Depicted on the clipboard back face 102 is a graphic which includes a playing area which in this case is a three dimensional partial depiction of a hockey rink 110 on a two dimensional surface referred to as 3-D image 108.

3-D image 108 is a schematic partial view of hockey rink 110 and includes the entire neutral zone 112 as well as the attacking zone 114. The reader will note that the attacking zone could also be the defending zone depending upon the direction of play. In other words 3-dimensional board 100 could be used to show players that are attacking net 120 or for showing players that are defending net 120.

3-D image 108 of hockey rink 110 depict the following features of ice playing surface 122 namely attackers blue line 116, defenders blue line 124, center face-off spot 126, center face-off circle 128, referees crease 130, face off spots 132 and center line 134.

3-D image 108 also shows an attacking zone 114, face off spots 136, face-off circle 138, goal line 140, net 120, goalie restricted area 142 which is sometimes also called the trapezoid as well as goal crease 144.

3-D image depicts horizontal features such as the ice playing surface 122 face off circles 138 and 126 and also vertical features such as the backboard 150, the side boards 146, and the side and back safety glass 148 and 152.

3-D Image 108 also shows peripheral area 111 which includes side boards 146, side safety glass 148, back boards 150 and back safety glass 152.

Referring now to FIG. 2 which shows a 2-D image 160 of a hockey playing surface 162 on clipboard front face 164 as well as clip board periphery 104 of clipboard 101.

FIG. 2 also shows clipping mechanism 107 as well as the front portion of clip fasteners 106.

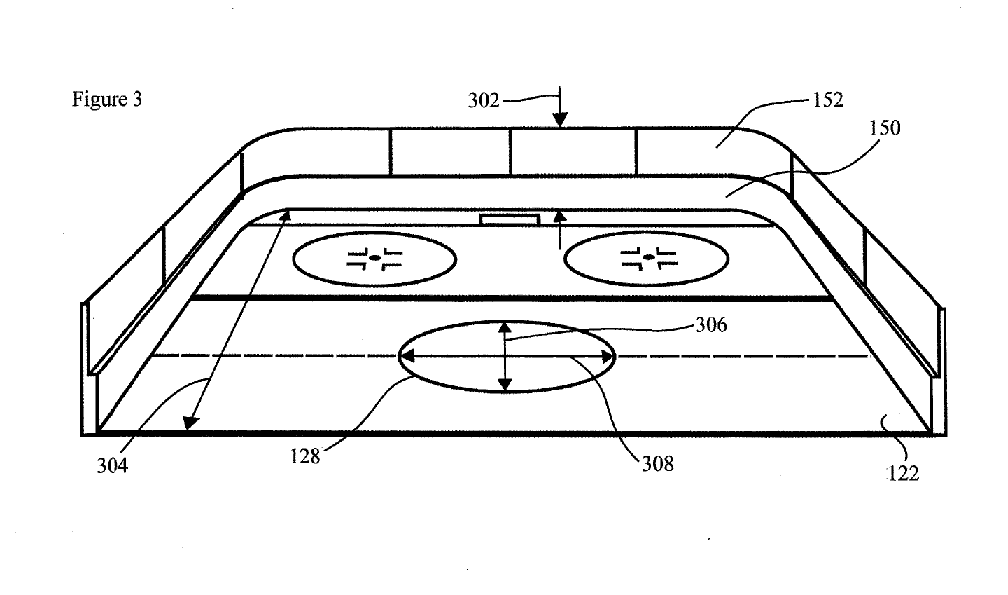

Referring now to FIGS. 3, 4 and 5 which show schematically a plan view of a back-face of clipboard displaying a partial 3-D image of a hockey rink at different viewing angles relative to the horizontal.

FIG. 3 for example shows the hockey rink 110 at a viewing angle of 20 degrees relative to the horizontal and the reader will take reference to the back height 302 of the rink length 304 the circle depth 306 and the circle width 308.

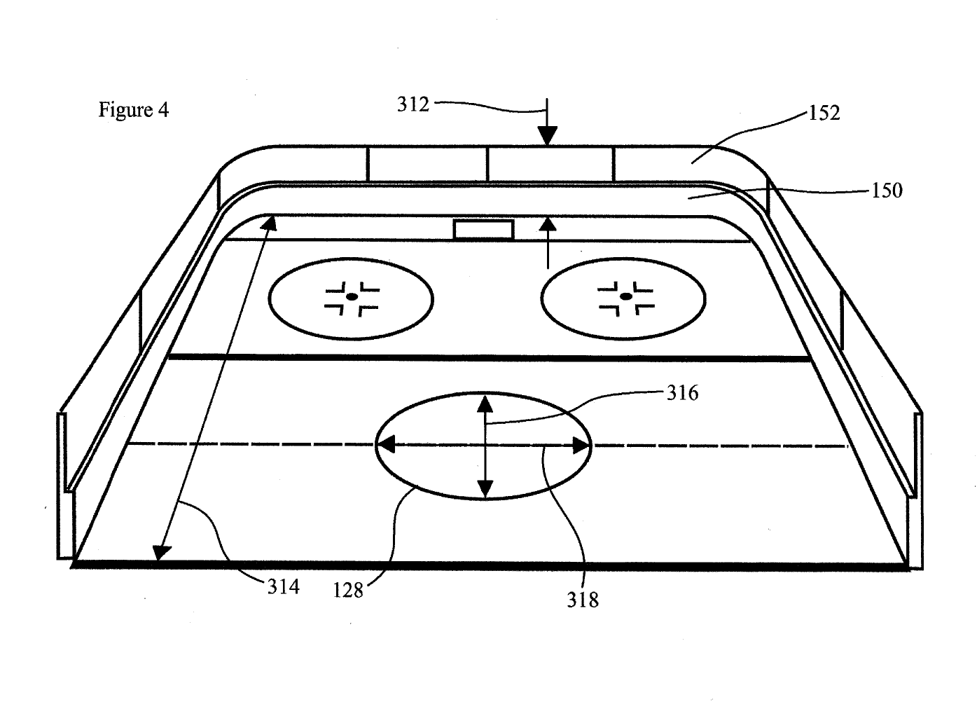

In FIG. 4 the back height is shown as 312, the rink length 314, the circle depth 314, the circle depth 316, and the circle width 318. FIG. 4 shows the hockey rink 110 at an angle of about 45 degrees.

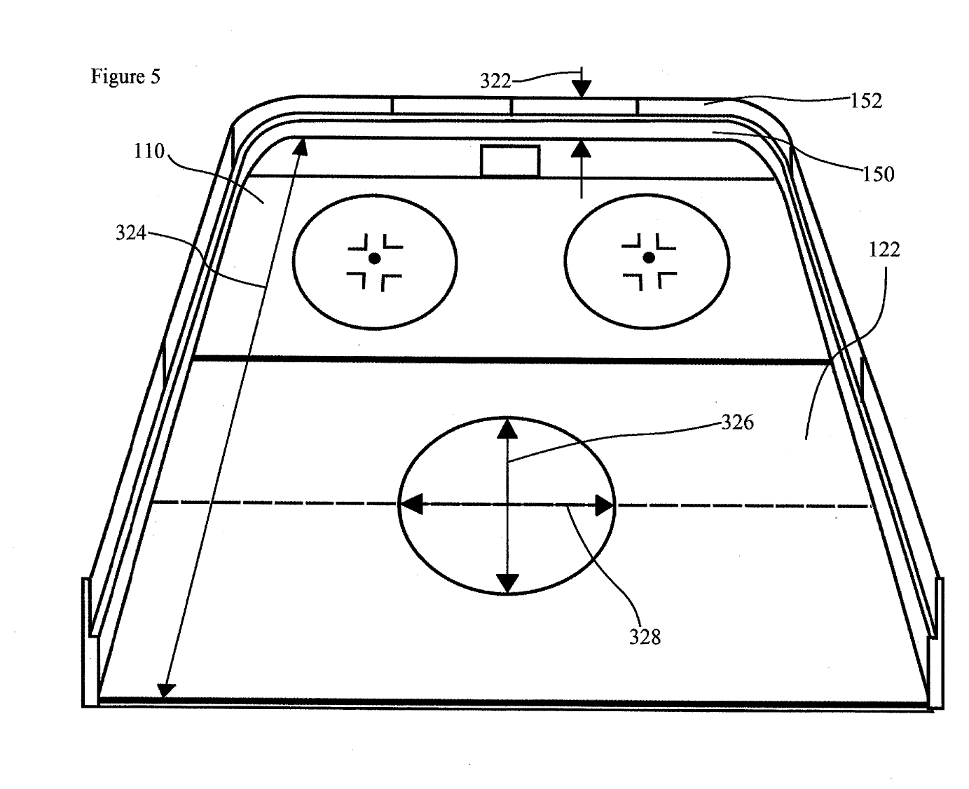

In FIG. 5 the back height is shown as 322, the rink length as 324, circle depth as 326 and the circle width at 328. FIG. 5 shows the hockey rink 110 at an angle of about 85 degrees.

As the viewing angle is lower relative to the horizontal for example at 20 degrees there is significant compression of the rink length 304 and distortion of the centre face-off circle 128 due to the compression of horizontal features. Centre face-off circle 128 actually appears as an ellipse due to the distortion wherein the circle depth 306 is significantly less than the circle width 308. Additionally the entire rink length 304 is also compressed. Vertical features such as back height 302 however is less distorted since the angle is only 20 degrees from the horizontal and back height 302 almost appears proportionally as the normal height. Back height 302 is comprised of backboard 150 and back safety glass 152.

Comparing FIG. 3 to FIGS. 4 and 5 one will note that as the viewing angle increases from 20 to 45 and then to 85 the back height 312 in two dimensions decreases significantly such that the back height becomes very small at an 85 degree angle.

In contrast the rink length 314 and 324 increases on the two dimensional clipboard surface relative to rink length 304 shown in FIG. 3 as the angle increase from 45 degrees to 85 degrees.

Centre faceoff circle 128 at the 45 degree viewing angle still appears somewhat elliptical wherein the circle depth 316 is less than the circle width 128 however the rink length 314 is somewhat longer and the back height 312 is somewhat less than back height 302, on the two dimensional clipboard surface.

Looking however at the 85 degree viewing angle one will see that the back height 322 has diminished significantly however the centre faceoff circle 128 now looks almost completely circular wherein the circle depth 326 is very close to the circle width 328 and the rink length 324 is at a maximum compared to the other views.

Therefore in summary at a small viewing angle such as 20 degrees or less there will be significant distortion of the horizontal features shown in the diagram in particular the ice playing surface 122 is length compressed such that the rink length 304 appears shorter and the centre faceoff circle 128 appears more of an ellipse than a circle. The vertical portions of the drawing however such as the backboards 150 and the back safety glass 152 will look more normal and have a relatively normal back height 302, at 20 degrees as in FIG. 3.

At the 45 degree angle there is some distortion of both the back height 312 and the rink length 314 and the centre faceoff circle 128 however the distortion in both the horizontal and the vertical portions is not extreme.

In FIG. 5 for example the back height 322 of back safety glass 152 and back boards 150 is extremely compressed and distorted however the rink length 324 and the centre faceoff circle 128 are less distorted wherein the circle depth 326 compared to the circle width 128 looks more circular and normal.

Therefore in selecting a viewing angle for 3-D image 108 one can see that at a very low viewing angle such as 20 degrees shown in FIG. 3 the ice playing surface 122 is badly distorted however the back safety glass 152 and back board 150 is less distorted. At the other extreme for example at a very high viewing angle relative to the horizontal namely 85 degrees shown in FIG. 5 one will see that the back height 322 is compressed and distorted namely the back safety glass 152 and the back boards 150 appear compressed and short whereas the ice playing surface 122 appears normal having a relatively normal looking rink length and centre faceoff circle.

The viewing angle of 45 degrees relative to the horizontal depicts a compromise between distortion of the horizontal features of the playing surface namely the ice playing surface 122 and distortion of the vertical features shown in the diagrams namely the backboard and the back safety glass 152.

In practice it has been found by the inventor that an angle somewhere between 20 and 80 degrees in usable however the most usable range is roughly between 30 and 70 degrees and the most preferred viewing angle is between 35 degrees and 55 degrees

### In Use

3-D image 108 has a number of advantages over for example 2-D image 160 shown in FIG. 2. 3-D image 108 shown in FIG. 1 allows for better depth perception and helps the user visualize the location on the ice. In other words there is a better feel for location and depth with the use of 3-D image 108 as opposed to a 2-D image 160 as shown in FIG. 2.

With the use of a 2-D image 160 it is only possible to give a 2-D direction such as to show a 2-D shot and/or instructions in other words on the plane of the ice, in the present example.

With the use of 3-D image 108 shown in FIG. 1 it is possible to show not only shot direction and location on for example ice playing surface 122 but one could also show for example use of a shot off of back board 150, off of back safety glass 152, off of side boards 146 and/or off of side safety glass 148. One could for example depict the height and location of the shot on the side 146 or backboards 150 to have the puck rebound to a certain location. These are shots which may in fact be used from time to time depending upon the situation that a team is confronted with. For example it is possible that one may want to use the safety glass 148 or 152 or for example the boards 150 or 146 in attempting to clear out a puck from your own end when you are confronted with a power play situation. It may be possible that one also wants to put the puck off of the back safety glass 152 near the net 120 in order to obtain a rebound which comes just in front of goal crease 144 of net 120. These types of shots are difficult or impossible to depict with a 2-D image 160 shown in FIG. 2 however are very possible and easily shown and depicted with 3-D image 108 as shown in FIG. 1.

It should be apparent to persons skilled in the arts that various modifications and adaptation of this structure described above are possible without departure from the spirit of the invention the scope of which defined in the appended claim.

I claim:

1. A coaching board in combination with an image displayed thereon, the combination comprising:
a) a planar coaching board with at least one erasable writing surface;
b) a 3-D image displayed on the erasable writing surface, the 3-D image is a graphic depiction of a sports playing area and includes both horizontal features and vertical features in a perspective view;
c) wherein the 3-D image is a perspective view of at least a portion of the playing area shown at a viewing angle of approximately 15° to 85° relative the horizontal.

2. The combination claimed in claim 1 wherein the sports playing area is chosen from among ice hockey rink, baseball diamond, volleyball court, American football field, soccer pitch, and basketball court.

3. The combination claimed in claim 2 wherein the horizontal feature includes a playing surface.

4. The combination claimed in claim 3 wherein the playing surface is chosen from among, ice surface, basketball court, volleyball court, baseball diamond, soccer pitch, football field, and basketball court.

5. The combination claimed in claim 4 wherein the vertical features is chosen from among, hockey boards, hockey safety glass, hockey net, soccer net, basketball net, football uprights, volleyball net, and baseball back walls.

6. The combination claimed in claim 2 wherein the 3-D image is a perspective view of at least a portion of the play surface shown at an angle of approximately 35° to 55° relative the horizontal.

7. The combination claimed in claim 2 wherein the playing surface including horizontal features selected from among boundary lines, face off circles, designated areas, and bases.

8. The combination claimed in claim 1 wherein the planar coaching board including a clip board.

9. The combination claimed in claim 1 wherein the planar coaching board includes a carry board.

10. The combination claimed in claim 1 wherein the planar coaching board includes a wallboard.

11. The combination claimed in claim 1 wherein at least one half of playing area is depicted on the planar coaching board.
